(19) United States
(12) Patent Application Publication
(10) Pub. No.: US 2009/0148255 A1
(43) Pub. Date: Jun. 11, 2009

(54) PAPER-SHEET HANDLING DEVICE

(75) Inventor: Kiichi Haramiishi, Gunma (JP)

Correspondence Address: SMITH-HILL AND BEDELL, P.C., 16100 NW CORNELL ROAD, SUITE 220, BEAVERTON, OR, 97006, US

(73) Assignee: MAX CO., LTD., Tokyo (JP)

(21) Appl. No.: 12/065,150

(22) PCT Filed: Aug. 29, 2006
(86) PCT No.: PCT/JP2006/317002

§ 371 Date: Feb. 28, 2008

(30) Foreign Application Priority Data
Sep. 1, 2005 (JP) 2005-254022

(51) Int. Cl. B42B 9/00

(52) U.S. Cl. 412/40

(57) ABSTRACT

A paper-sheet handling device is provided with a movement mechanism for inserting both tips of a binding component into perforated holes of paper-sheets; the movement mechanism has a binding component gripping portion which holds a binding component of a predetermined size in an opened state thereof and which is adjustable upward and downward in conformity with a size of a diameter of the binding component, and binding claws for inserting the both tips of the binding component into the perforated holes of the paper-sheets by pushing inward from both sides; and the both tips of the binding claws come into contact with an arc portion of the binding component at the most suitable position thereof. Thus, the load imposed onto the arc portion of the binding component can be kept substantially constant and at the same time, the useless load imposed onto the arc portion can be eliminated.

### TECHNICAL FIELD

This invention relates to a preferable paper-sheet handling device which is applied to a device for performing a punching process and a binding process or the like on recording paper-sheets released from a copy machine, a print machine or the like for black-and-white use and for color use. Particularly, an insertion mechanism for inserting both tips of a binding component into perforated holes of paper-sheets is provided, the binding component of a predetermined size is held in an opened state thereof, a position of the binding component is adjusted upward or downward in conformity with a size of a diameter of this binding component, and the both tips of the binding component are inserted into the perforated holes of the paper-sheets by pushing inward from both sides, thereby enabling the most suitable position to contact with respect to arc portions of the binding components of different diameters to inside from both sides, allowing the load imposed onto the arc portion of the binding component to keep substantially constant, and at the same time, allowing the useless load imposed onto the arc portion to be eliminated.

### BACKGROUND ART

In recent years, a case in which a copy machine, a print machine or the like for black-and-white use and for color use is used by combining a paper-sheet handling device that carries out the perforation and binding processing has been increased. According to this kind of paper-sheet handling device, recording paper-sheets after the picture formation are received and is perforated on the downstream side of the paper-sheets thereof by utilizing the punching function. A plurality of paper-sheets after the perforation is aligned once again. A binding component is inserted automatically into perforated holes of the plurality of paper-sheets after the alignment.

On the other hand, when the binding component is automatically inserted into the perforated holes of the plurality of paper-sheets, fixing member for holding and fixing the binding component and insertion member for inserting the held and fixed binding component are used. The fixing member receives the developed binding component of a predetermined size from a binding component storing unit and holds and fixes it in a state of development. Also, the insertion member inserts the binding component held and fixed in the developed state by the fixing member to the perforated holes of the plurality of paper-sheets.

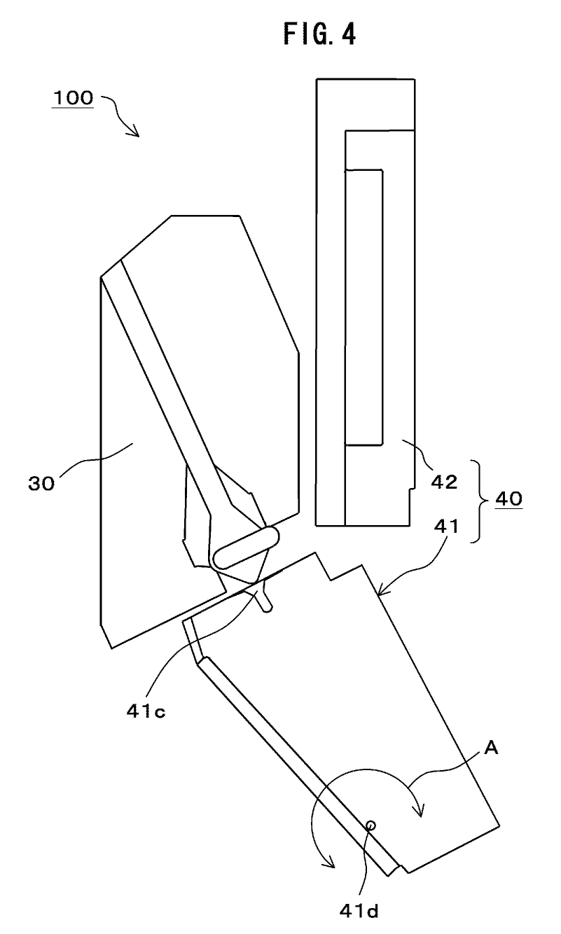

For example, a binding device has been disclosed in Japanese unexamined patent publication No. 2003-320780 (second page, FIG. 4). According to this binding device, when loose-leaf paper-sheets are bound by using a plastic made binder in which partitioned ring portions are arranged in parallel in both sides of a backbone portion, an elevator type stopper portion is provided, this elevator type stopper portion is located at a front of the backbone portion of the binder held by the binder holding portion and also a rear side of the loose-leaf paper-sheet on a paper-sheet table, and carries out a positioning of the loose-leaf paper-sheets. Such a configuration of the device enables the binder to be inserted into the holes inside of the loose-leaf paper-sheets.

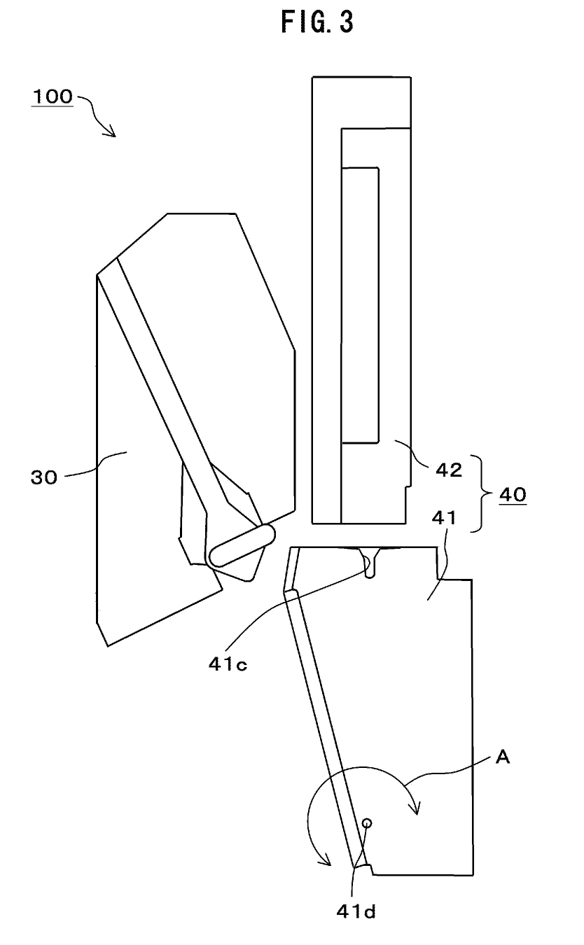

Also, a binding process device has been disclosed in Japanese unexamined patent publication No. 2005-59396 (second page, FIG. 3). According to this binding process device, when loose-leaf paper-sheets in each of which a plurality of punch holes are formed along one side of paper are automatically bound by a binder, one pair of up and down pushers, an elevator drive mechanism which moves the pair of up and down pushers up and down symmetrically, and a drive motor are provided, in which the pair of pushers are driven in the closing direction, thereby closing the partitioned ring portions of the binder to sandwich the backbone portion of the binder, so that the partitioned ring portions forming a pair are inserted into the punch holes of the loose-leaf paper-sheets. Such a configuration of the device enables the stability in the insertion operation of the partitioned ring portions to be improved, and the occurrence of the insertion defection to be reduced.

### DISCLOSURE OF THE INVENTION

### Problem to be Solved by the Invention

However, relative to the paper-sheet handling devices in the conventional system, for example, the paper-sheet handling device as seen in Japanese unexamined patent publication No. 2003-320780 (second page, FIG. 4) fixes the position of the binder at a set position by the elevator type stopper portion, so at the time of changing the size of the binder binding component, the unnecessary load is imposed onto arc portion of the binder, consequently, there is a fear that the insertion accuracy is lowered. Also, in the paper-sheet handling device as seen in the unexamined patent publication No. 2005-59396 (second page, FIG. 3), similarly, the position of the backbone portion of the binder is fixed uniformly, so at the time of changing the size of the binder, the unnecessary load is imposed onto the arc portion of the binder, consequently, there is a fear that the insertion accuracy is lowered.

### Means for Solving the Problem

For solving the aforesaid problems, a paper-sheet handling device according to claim 1 relates to a paper-sheet handling device for producing a booklet by binding a binding component into holes perforated at predetermined positions of respective plural paper-sheets, which is provided with a binding component storing unit for storing the binding component of a predetermined size that is developed before processing and becomes a ring shape after the processing and binding means for receiving the binding component of the predetermined size from the aforesaid binding component storing unit and for binding the aforesaid binding component into the holes perforated at the predetermined positions of the aforesaid paper-sheets. The aforesaid binding means has an insertion mechanism for inserting both tips of the aforesaid binding component into the perforated holes of the aforesaid paper-sheets. The aforesaid insertion mechanism has a holding member which holds the aforesaid binding component of the predetermined size in an opened state thereof and which is adjustable upward and downward in conformity with a size of a diameter of the aforesaid binding component, and an insertion member for inserting the both tips of the aforesaid binding component held by the aforesaid holding member into the perforated holes of the aforesaid paper-sheets by pushing the both tips of the aforesaid binding component to inside from both sides.

According to the paper-sheet handling device according to the present invention, if the booklet is produced by binding the binding component into the holes perforated at predetermined positions of respective plural paper-sheets, the insertion mechanism for inserting the both tips of the binding component into the perforated holes of the paper-sheets is included and the insertion mechanism has the holding member and the insertion member. The holding member holds the binding component of the predetermined size in the opened state thereof and is adjustable upward and downward in conformity with the size of the diameter of the binding component. The insertion member inserts the both tips of the binding component into the perforated holes in the paper-sheets by pushing the both tips of the binding member held by the holding member to the inside from the both sides.

Accordingly, the both tips of the insertion member contact to each other at the most suitable position with respect to the arc portions of the binding components of the different diameters, so that the load imposed onto the arc portion of the binding component can be kept substantially constant. Thus, the useless load imposed onto the arc portion can be eliminated. Thus, miniaturization of motors and components become possible and the environmental load can be reduced.

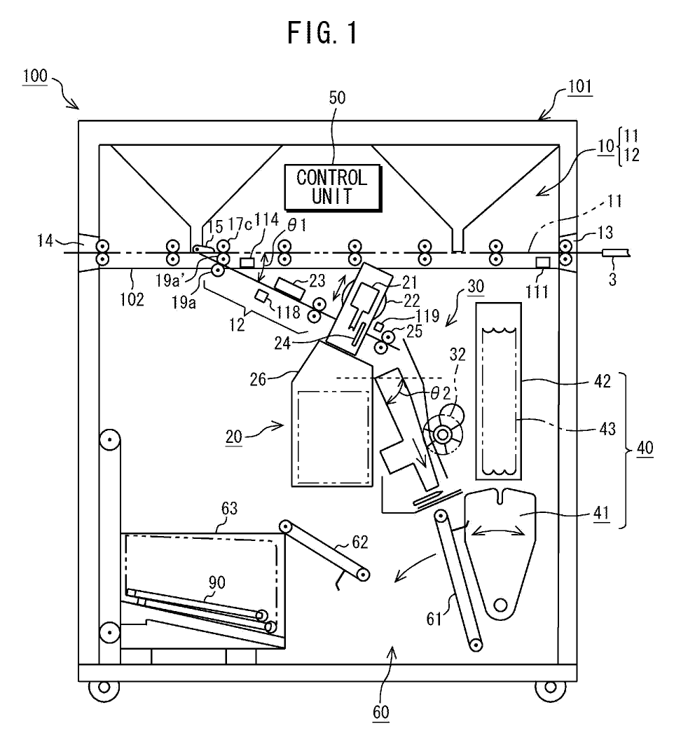

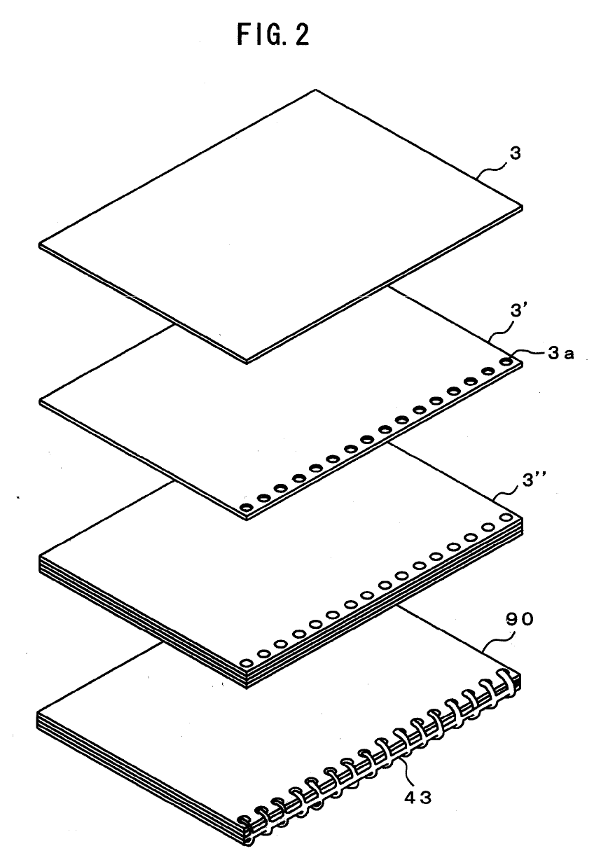

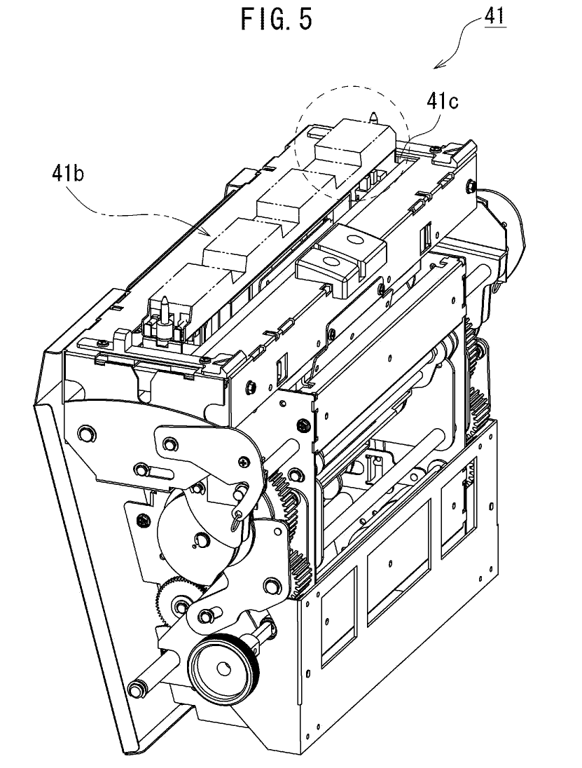

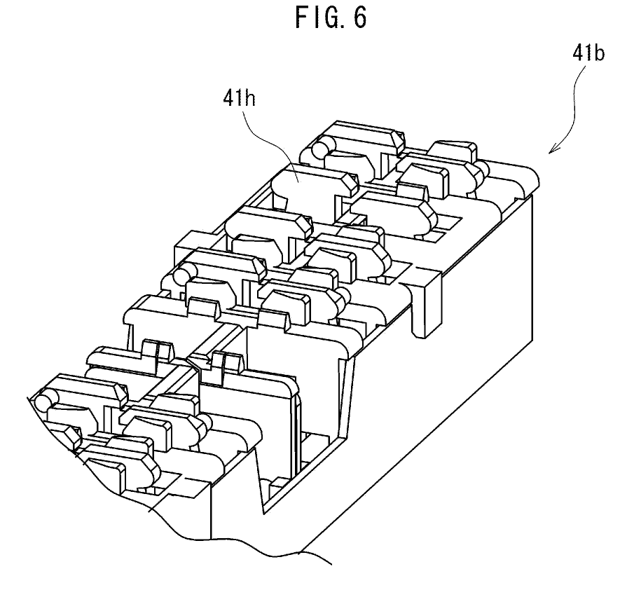

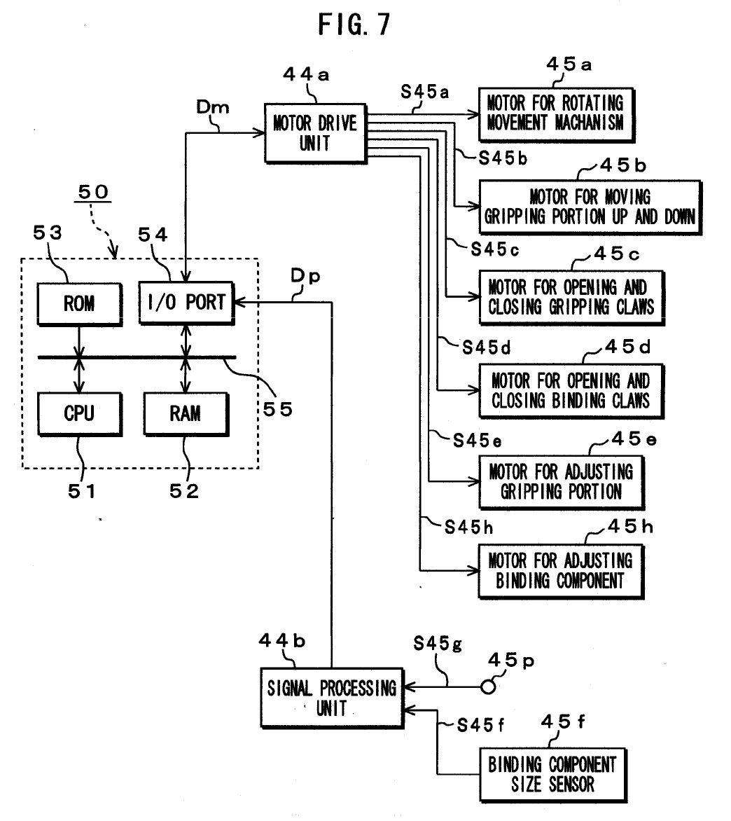

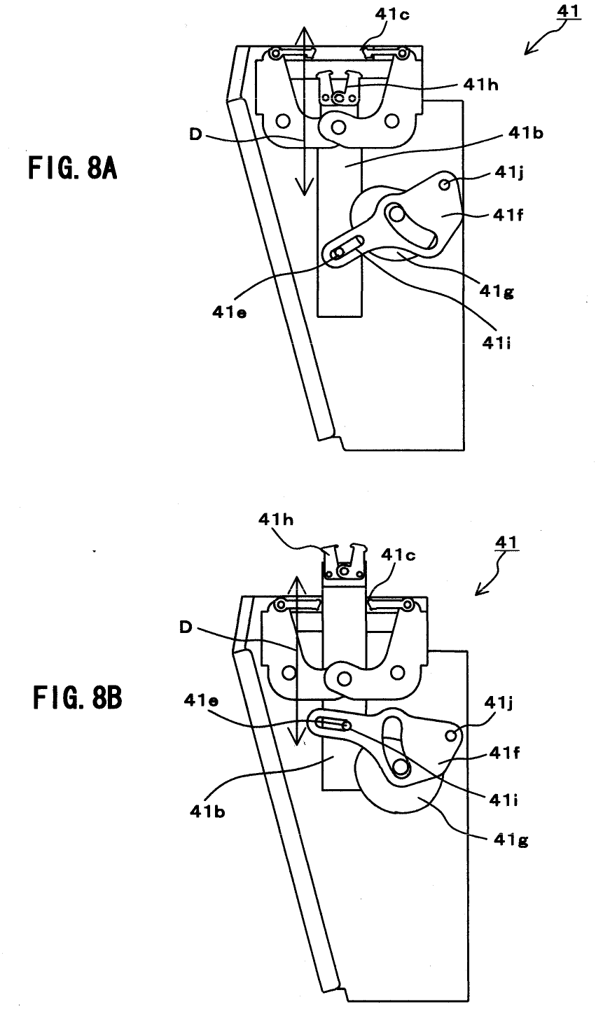

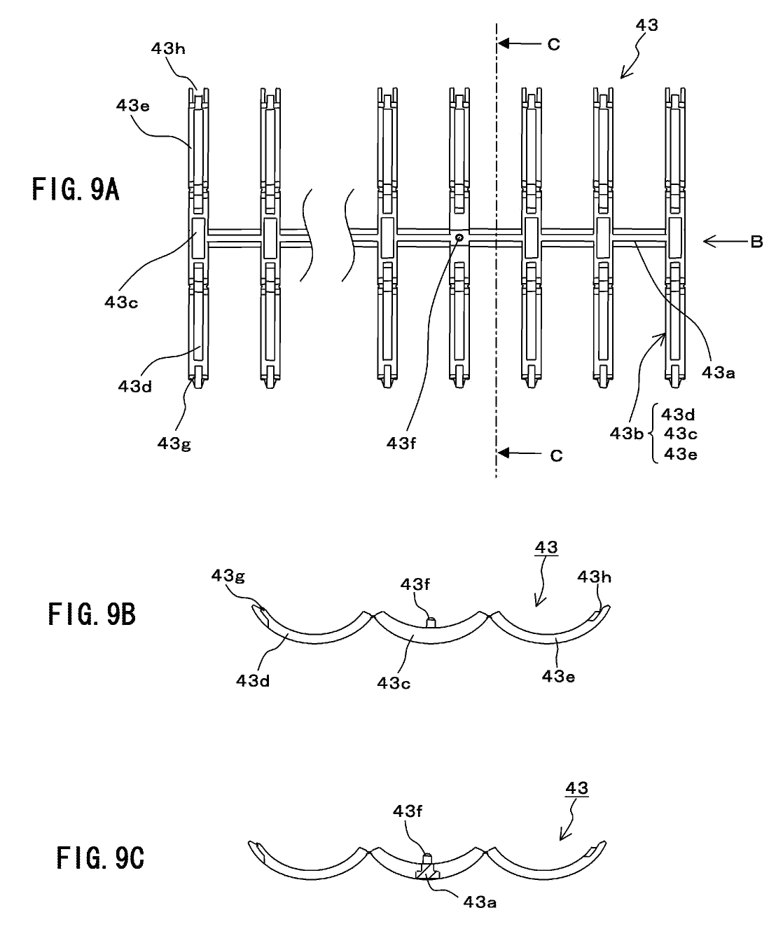

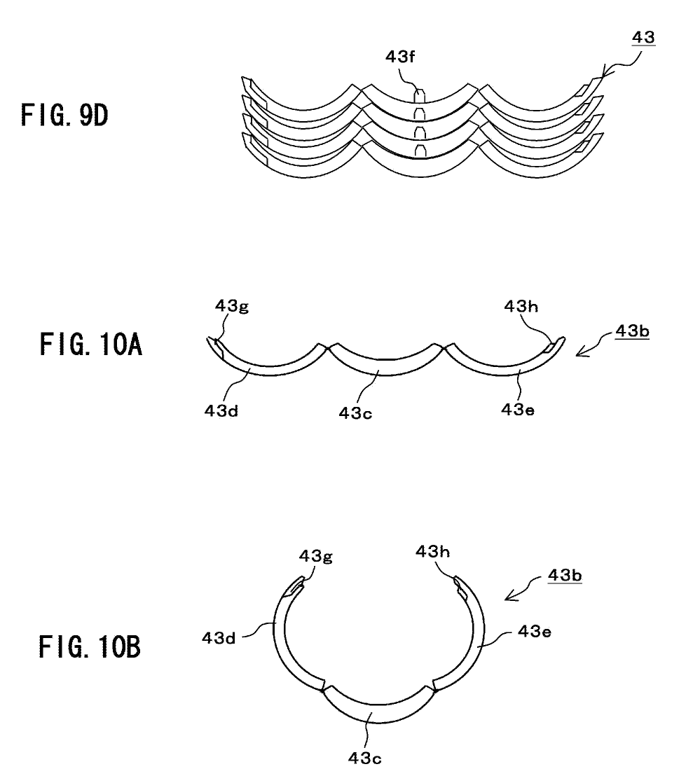

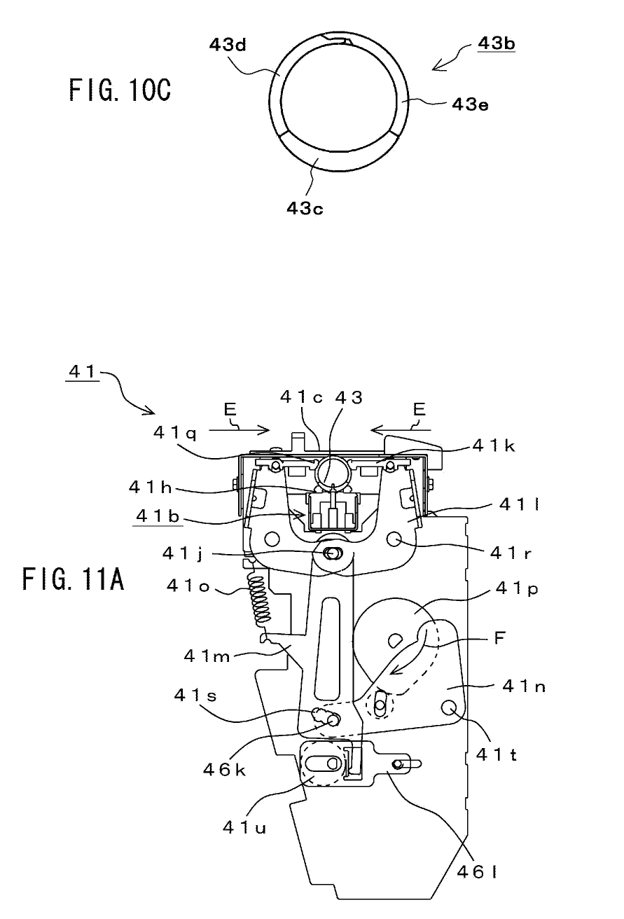

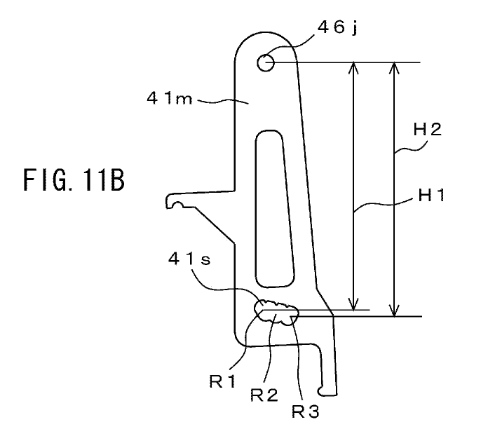

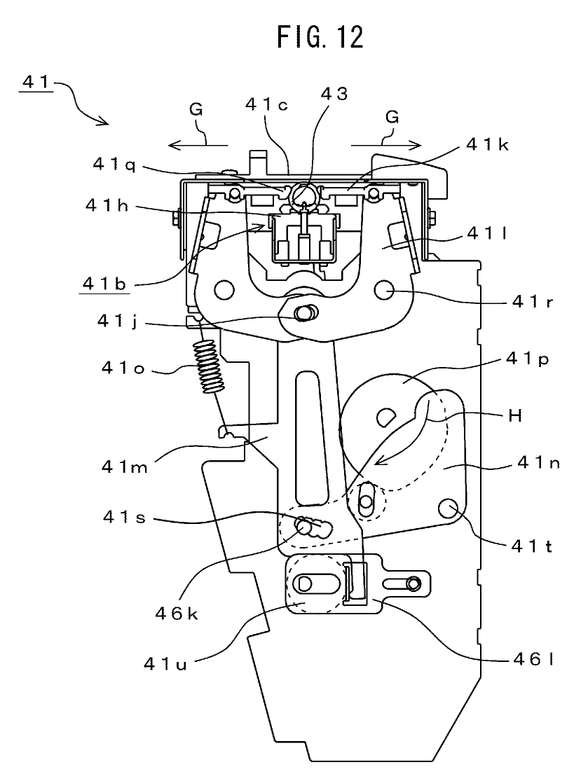

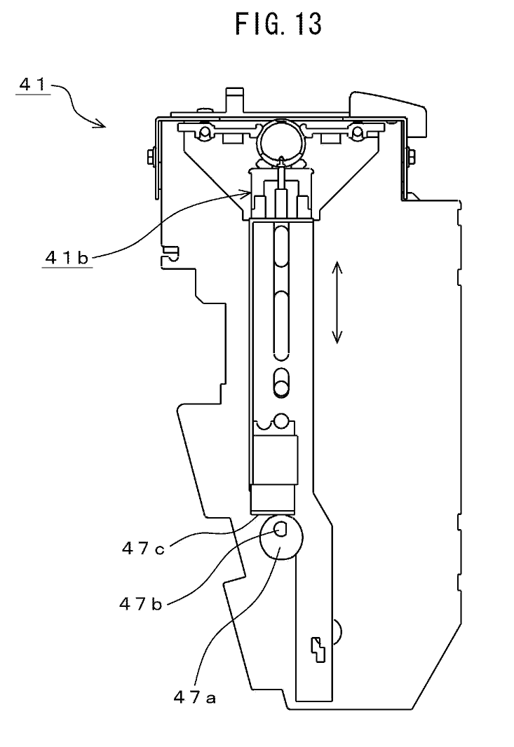

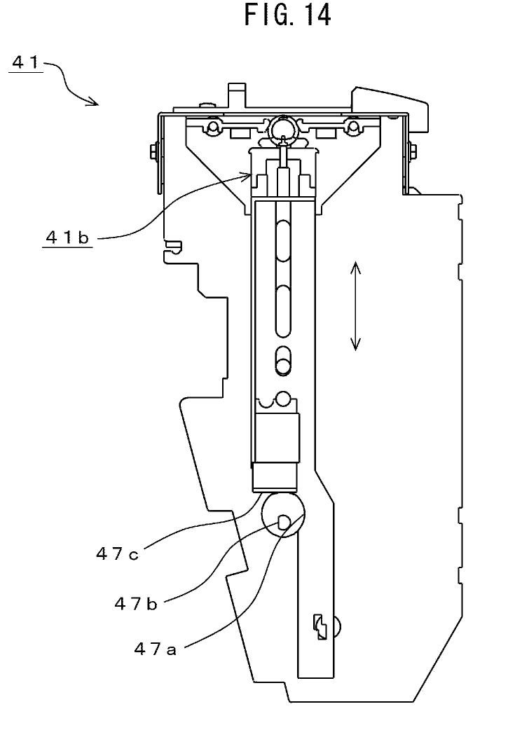

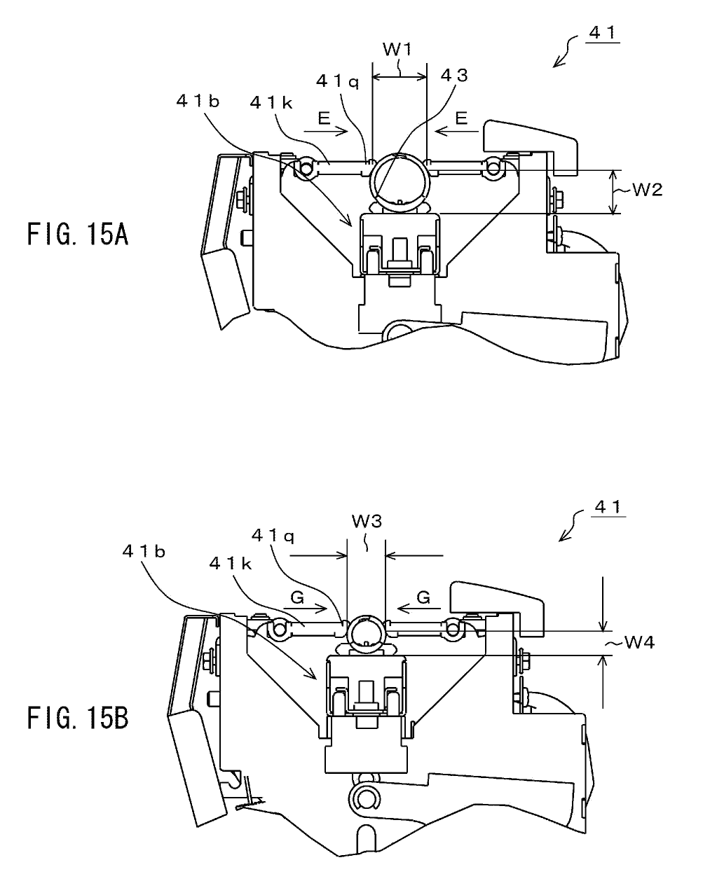

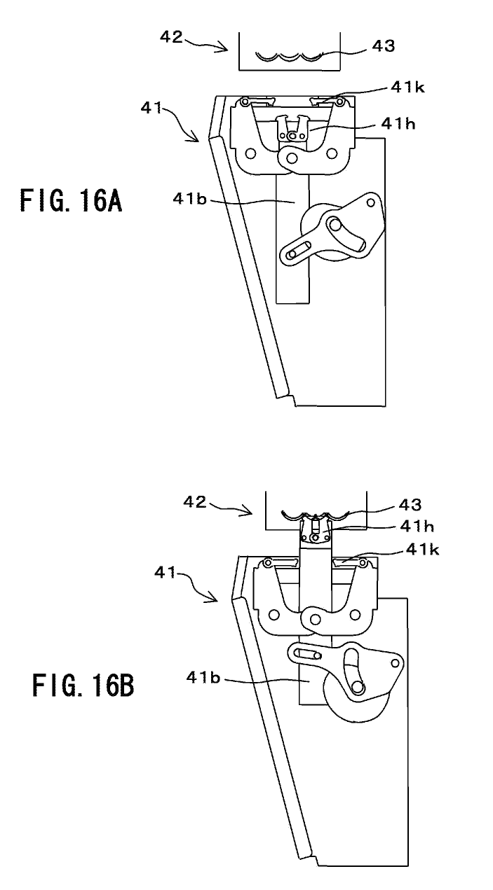

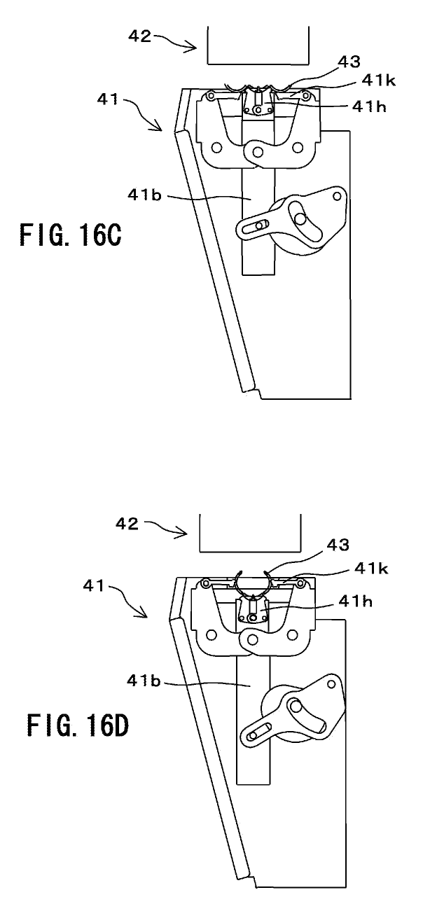

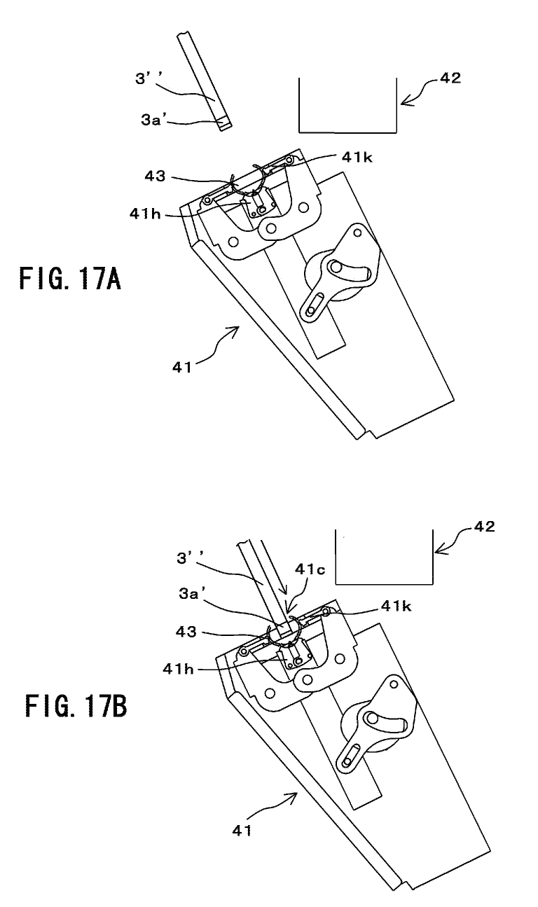

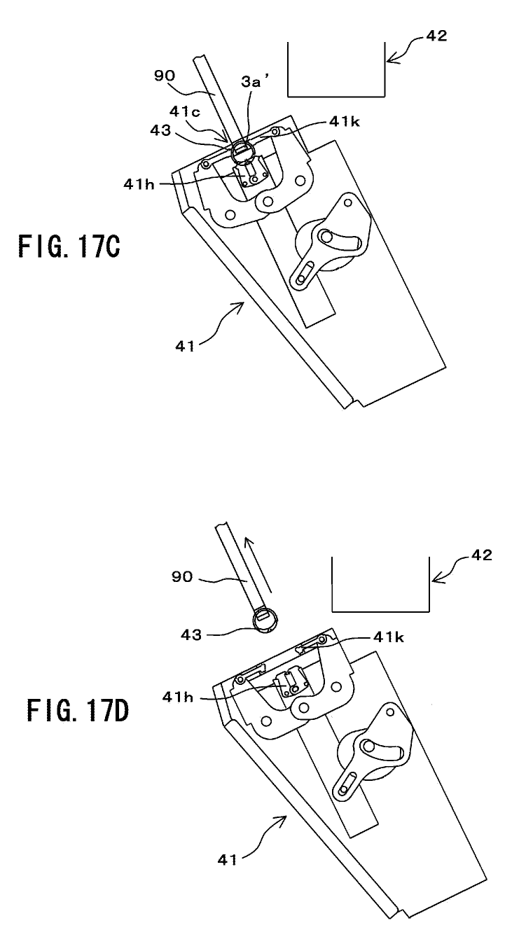

### BRIEF DESCRIPTION OF DRAWINGS

[FIG. 1] is a conceptual diagram showing a configuration example of a binding device 100 to which a paper-sheet handling device as an embodiment according to the present invention is applied.

[FIG. 2] is a process diagram showing a function example of the binding device 100.

[FIG. 3] is a schematic diagram showing a configuration example (binding component acquisition) of a binding process unit 40 and a paper alignment unit 30.

[FIG. 4] is a schematic diagram showing a configuration example (binding process) of the binding process unit 40 and paper alignment unit 30.

[FIG. 5] is a schematic diagram showing a configuration example of a movement mechanism 41.

[FIG. 6] is a schematic diagram showing a configuration example of a binding component gripping portion 41b.

[FIG. 7] is a block diagram showing a configuration example of a control system of the binding process unit 40.

[FIG. 8A] is a diagram showing a state example in which the binding component gripping portion 41b is positioned at the lowermost portion.

[FIG. 8B] is a diagram showing a state example in which the binding component gripping portion 41b is positioned at the uppermost portion.

[FIG. 9A] is a plan view showing a portion of a constitution example of a binding component 43.

[FIG. 9B] is a side view showing a state example of the binding component 43 seen from an arrow B.

[FIG. 9C] is a cross-section diagram of the binding component 43 seen from C-C arrows.

[FIG. 9D] is a diagram showing a state example when seeing from an arrow B a state in which a plurality of binding components 43 is stacked.

[FIG. 10A] is a diagram showing a development example of a ring portion 43b.

[FIG. 10B] is a diagram showing a half-binding example of the ring portion 43b.

[FIG. 10C] is a diagram showing a binding example of the ring portion 43b.

[FIG. 11A] is a conceptual diagram of a cross-section showing a configuration example of the movement mechanism 41 (when binding a binding component of large diameter).

[FIG. 11B] is a diagram showing a configuration example of a binding claw link B41m.

[FIG. 12] is a schematic diagram of a cross-section showing a configuration example of the movement mechanism 41 (when binding a binding component of small diameter.

[FIG. 13] is a conceptual diagram of a cross section showing a configuration example of the movement mechanism 41 (when holding the binding component of large diameter).

[FIG. 14] is a conceptual diagram of a cross section showing a configuration example of the movement mechanism 41 (when holding the binding component of small diameter).

[FIG. 15A] is a conceptual diagram of a portion of a cross section showing a function example of the movement mechanism 41 (binding component of large diameter).

[FIG. 15B] is a conceptual diagram of a portion of a cross section showing a function example of the movement mechanism 41 (binding component of small diameter).

[FIG. 16A] is a diagram showing a state example of the binding component gripping portion 41b positioned at the lowermost portion.

[FIG. 16B] is a diagram showing a state example where the binding component 43 is gripped by means of binding component gripping claws 41h.

[FIG. 16C] is a diagram showing a state example where the binding component 43 contacts binding claws 41k.

[FIG. 16D] is a diagram showing a movement example toward the lower side of the binding component gripping portion 41b.

[FIG. 17A] is a diagram showing a movement example to a paper-sheet binding position of the movement mechanism 41.

[FIG. 17B] is a diagram showing a movement example of a bundle of paper-sheets 3″ with respect to the binding component 43.

[FIG. 17C] is a diagram showing an operation example of the binding claws 41k when binding the binding component 43 with respect to the bundle of paper-sheets 3″.

[FIG. 17D] is a diagram showing a movement example of the bundle of paper-sheets 3″ and an operation example of the movement mechanism 41 after the time of the binding.

### BEST MODE FOR CARRYING OUT THE INVENTION

This invention has an object to provide a paper-sheet handling device such that the load imposed onto an arc portion of a binding component can be kept substantially constant and at the same time, the useless load imposed onto the arc portion can be eliminated. Hereinafter, the paper-sheet handling device according to an embodiment of the invention will be explained with reference to the drawings.

FIG. 1 is a conceptual diagram showing a configuration example of a binding device 100 to which a paper-sheet handling device as an embodiment of the present invention is applied.

The binding device 100 shown in FIG. 1 is a device which constitutes one example of the paper-sheet handling device producing a booklet by binding a binding component (consumables) 43 into holes perforated at predetermined positions of respective plural paper-sheets, performs a punching process on recording paper (hereinafter, merely referred to as paper-sheet 3) output from a copy machine or a print machine and thereafter, releases the papers after processing a binding process by a predetermined binding component 43. Of course, it may be applied to a device provided with a function of perforating a hole on a predetermined paper-sheet 3 and outputting the paper directly without any change. The binding device 100 has a device body portion (housing) 101. It is preferable for the binding device 100 to be used in conjunction with a copy machine, a printing machine (picture forming device) or the like, and the device body portion 101 has a comparable height as that of a copy machine, a printing machine or the like.

A paper-sheet transport unit 10 is provided in the device body portion 101. The paper-sheet transport unit 10 has a first transport path 11 and a second transport path 12. The transport path 11 has a paper-feed inlet 13 and an outlet 14 and has a through-pass function for transporting the paper-sheet 3 drawn from the paper-feed inlet 13 toward the outlet 14 that becomes the predetermined position.

Here, the through-pass function means a function such that the transport path 11 positioned between a copy machine, a printing machine or the like on the upstream side and other paper-sheet handling device on the downstream side directly delivers the paper-sheet 3 from the copy machine, the printing machine or the like to the other paper-sheet handling device. In a case in which the through-pass function is selected, it is configured that the acceleration process of the transport rollers, the binding process or the like is omitted. The paper-sheet 3, usually, in case of one-side copy, is delivered in a state of the face down. It is configured that a paper feed sensor 111 is mounted on the paper-feed inlet 13 so as to output a paper feeding detection signal to a control unit 50 by detecting a front edge of the paper-sheet 3.

The transport path 12 has a switchback function by which the transport path is switchable from the aforesaid transport path 11. Here, the switchback function means a function that decelerates and stops the transport of the paper-sheet 3 at a predetermined position of the transport path 11, thereafter, switches the transport path of the paper-sheet 3 from the transport path 11 to the transport path 12, and also, delivers the aforesaid paper-sheet 3 in the reverse direction. It is configured that a flap 15 is provided in the transport path 11 to switch the transport path from the transport path 11 to the transport path 12.

Also, three cooperative transport rollers 17c, 19a′, 19a are provided at a switch point between the transport path 11 and the transport path 12. The transport rollers 17c and 19a rotate clockwise and the transport roller 19a′ rotates semi-clockwise. For example, it is constituted such that the transport roller 19a′ is a drive roller and the transport rollers 17c and 19a are driven rollers. The paper-sheet 3 taken by the transport rollers 17c and 19a′ decelerates and stops, but when it is restricted from the upper side to the lower side by the flap 15, it is transported to the transport path 12 by being fed by the transport rollers 19a′ and 19a. It is configured that a paper-sheet detecting sensor 114 is disposed just before the three cooperative transport rollers 17c, 19a′ and 19a, detects the front end and the rear end of the paper-sheet, and outputs a paper-sheet detection signal S14 to the control unit 50.

A punching process unit 20 is arranged on the downstream side of the transport path 12. In this embodiment, it is designed so as to have a predetermined angle between above-mentioned transport path 11 and transport path 12. For example, a first depression angle θ1 is set between a transport surface of the transport path 11 and a paper-sheet surface to be perforated of the punching process unit 20. Here, the paper-sheet surface to be perforated means a surface where holes are perforated in the paper-sheet 3. The punching process unit 20 is arranged so that the paper-sheet surface to be perforated can be set to a position having the depression angle θ1 on the basis of the transport surface of the transport path 11.

In the punching process unit 20, it is configured that two or more holes for the binding are perforated at the one end of the paper-sheet 3 which switchbacks from the transport path 11 and is transported by the transport path 12. The punching process unit 20 has, for example, a motor 22 that drives a shuttle operable punch blade 21. The paper-sheets 3 are perforated by the punch blade 21 driven by the motor 22 for every sheet.

An openable and closable fence 24 that becomes a reference of the perforation position is provided in the punching process unit 20 and is used so as to strike the paper-sheet 3 thereto. Further, a side jogger 23 is provided in the punching process unit 20 so that the posture of the paper-sheet 3 is corrected. For example, a front edge of the paper-sheet 3 is made to be attached uniformly to the openable and closable fence 24. The fence 24 becomes a positional reference at the time of aligning the paper-sheet edge portion. A paper-sheet detecting sensor is disposed on the near side of the side jogger 23, detects the front end and the rear end of the paper-sheet, and outputs a paper-sheet detection signal S18 to the control unit 50.

The punching process unit 20 stops the paper-sheet 3 by attaching it to the fence 24 and thereafter, perforates the front edge of aforesaid paper-sheet 3. It should be noted that there is provided with a punch scrap storing unit 26 on the lower side of the punching processing main body and the punch scrap cut off by the punch blade 21 is made to be stored therein. It is configured that a paper output roller 25 is provided on the downstream side of the punching process unit 20 and transports the paper-sheet 3′ after the paper-sheet perforation (see FIG. 2) to the unit of the succeeding stage.

It is configured that a paper alignment unit 30 is arranged on the downstream side of the punching process unit 20 and holds (stores) temporarily a plurality of paper-sheets 3′ which are paper-outputted from the punching process unit 20 with the hole positions thereof being aligned. The paper alignment unit 30 is arranged so as to set the paper-sheet holding surface at the position having a second depression angle θ2 by making a transport surface of a transport unit 11 to be a reference. Here, the paper-sheet holding surface means the surface that holds (stacks) paper-sheets 3′ in each of which the holes are perforated. In this embodiment, a relation between the depression angle θ1 and the depression angle θ2 is set as θ1<θ2. This setting is for miniaturizing a width of the main body device 101 and for transporting the paper-sheet 3′ in a straight way under this condition.

It is configured that the paper alignment unit 30 has a paper-sheet guide pressing function and guides the paper-sheet 3′ to a predetermined position when the paper proceeds and after the paper proceeding is completed, the rear end side of the paper-sheet 3′ is immobilized. It is also configured that the paper alignment unit 30 has an alignment function of the paper-sheet front edge corner portion and guides the front end of the paper-sheet 3′, at the time of the paper proceeding, to a proper position of a multiple paddles shaped rotating member (hereinafter, referred to as paddle roller 32) for aligning the front end and side end of the paper-sheet 3′ to the reference position.

It is configured that in the downstream side of the paper alignment unit 30, a binding process unit 40 that constitutes one example of binding means for receiving the binding component 43 of a predetermined size from a binder cassette 42, which constitutes one example of a binding component storing unit for storing the binding component 43 of the predetermined size that is developed before processing and becomes a ring shape after the processing, and for binding the binding component 43 into the holes perforated in the paper-sheet 3′ at predetermined positions, is arranged and a booklet 90 is produced by binding a bundle of plural paper-sheets aligned by the aforesaid unit 30 with the binding component 43. The booklet 90 means the bundle of paper-sheets bound by inserting the binding component 43 thereinto.

In the embodiment, the binding process unit 40 has a movement mechanism 41 constituting one example of an insertion mechanism for inserting both tips of the binding component 43 into the perforated holes of the paper-sheet 3′. The movement mechanism 41 moves to shuttle between the transporting direction of the paper-sheet in the paper alignment unit 30 and a position perpendicular to the transporting direction in the aforementioned transport unit 11 in a revolving way. The binding process unit 40 has the binder (binding component) cassette 42. The plurality of binding components 43 are set in the binder cassette 42. The binding component 43, for example, is made in the injection molding and a plurality of kinds thereof in response to the thickness of the bundle of paper-sheets is prepared.

The movement mechanism 41, for example, pulls out one piece of binding components 43 from the binder cassette 42 at the position perpendicular to the transporting direction of the transport unit 11 and holds it and in this state, the movement mechanism 41 rotates to a position from which the paper-sheet transporting direction of the paper alignment unit 30 can be looked over. At this position, the binding process unit 40 receives the bundle of paper-sheets whose punch holes are position-determined from the paper alignment unit 30 and inserts the binding component 43 into the punch holes thereof to execute the binding process (automatic book-making function).

It is configured that in the downstream side of the binding process unit 40, a release unit 60 is arranged and the release processing for the booklet 90 produced by the binding process unit 40 is carried out. The release unit 60 is constituted so as to include, for example, a first belt unit 61, a second belt unit 62, and a stacker 63.

It is configured that the belt unit 61 receives the booklet 90 that is dropping from the paper alignment unit 30 and to switch the delivery direction thereof. For example, it is configured that the belt unit main body is turned around toward a predetermined release direction from the position from which the paper-sheet transporting direction of the paper alignment unit 30 can be looked over.

It is configured that the belt unit 62 receives the booklet 90 whose delivery direction is switched by the belt unit 61 and to transport it in the relay manner. It is configured that the stacker 63 accumulates the booklets 90 transported by the belt units 61 and 62.

Subsequently, a paper-sheet processing method according to the present invention will be explained. FIG. 2 is a process diagram showing a function example of the binding device 100.

The paper-sheet 3 shown in FIG. 2 is one which is paper-fed from the upstream side of the aforesaid binding device 100. It is one in which punch holes are not perforated. The paper-sheet 3 is transported directed to a predetermined position of the transport path 11 shown in FIG. 1 and is decelerated and stopped at a predetermined position of the transport path 11. Thereafter, the transport path of the paper-sheet 3 is switched from the transport path 11 to the transport path 12 and also, the aforesaid paper-sheet 3 is delivered in the reverse direction and is transported to the punching process unit 20.

In the punching process unit 20, a predetermined number of holes for the binding is perforated at one edge of the paper-sheet 3. The paper-sheet 3′ perforated with the holes for the binding is transported to the paper alignment unit 30. When reaching a preset quantity of the paper-sheets, it is configured that in the paper alignment unit 30, the positions of the holes for the binding thereof are aligned, for example, as the paper-sheets 3″ and the binding component 43 is inserted into the holes thereof under the cooperation of the binding process unit 40. This enables the booklet 90 inserted with the binding component 43 to be obtained.

FIG. 3 is a schematic diagram showing a configuration example (binding component acquisition) of the binding process unit 40 and the paper alignment unit 30. The binding process unit 40 shown in FIG. 3 is provided with the binder cassette 42 and the movement mechanism 41. The binding components 43 (which are not shown) are stacked and stored in the binder cassette 42. The movement mechanism 41 has an opening portion 41c and acquires the binding components 43 stacked in the binder cassette 42 from the opening portion 41c by one piece by one round. After the acquisition, as shown in FIG. 4, the movement mechanism 41 rotates in the counterclockwise direction on the axis of a movement mechanism rotating axis 41d and moves toward the paper alignment unit 30. In the paper alignment unit 30, the plural perforated paper-sheets are stored.

FIG. 4 is a schematic diagram showing a configuration example (binding process) of the binding process unit 40 and the paper alignment unit 30. The movement mechanism 41 shown in FIG. 4 has the opening portion 41c, is a rotated state in the counterclockwise direction on the axis of the movement mechanism rotating axis 41d from the state shown in FIG. 3, and inserts the binding component 43 (which is not shown) held by a binding component gripping portion 41b shown in FIGS. 5A and 5B into the paper-sheets 3″ shown in FIG. 2 provided from the paper alignment unit 30. After the insertion, the movement mechanism 41 releases the binding component 43 and rotates in the clockwise direction on the axis of the movement mechanism rotating axis 41d and moves to a position right under the binder cassette 42, which is the state shown in FIG. 3. The paper-sheets 3″ are bound with the binding component so that the booklet 90 can be formed, and thereafter, the process proceeds to a next paper-sheet processing step.

FIG. 5 is a schematic diagram showing a configuration example of the movement mechanism 41. The movement mechanism 41 shown in FIG. 5 has the opening portion 41c and the binding component gripping portion 41b. FIG. 6 is a schematic diagram obtained by enlarging the inside of the dotted circle of the binding component gripping portion 41b shown in FIG. 5. The binding component gripping portion 41b shown in FIG. 6, which constitutes one example of a holding member, is constituted such that it holds the binding component 43 of a predetermined size with being opened and is adjustable upward and downward in conformity with the size of a diameter of the binding component 43. The binding component gripping portion 41b moves up and down and acquires any one of the binding components 43 (which is not shown) stacked in the binder cassette 42 shown in FIG. 3. For example, when the movement mechanism 41 shown in FIG. 5 is a waiting state which is the state before acquiring the binding component 43, the binding component gripping portion 41b is positioned inside of the movement mechanism 41 and, when the waiting state is released, more specifically, in a case in which the plurality of paper-sheets stored in the paper alignment unit 30 shown in FIG. 3 are reached to the preset number of sheets and the binding component is inserted, the binding component gripping portion 41b positioned inside the movement mechanism 41 moves upward to the outside of the movement mechanism 41 from the opening portion 41c and acquires the binding component 43.

FIG. 7 is a block diagram showing a configuration example of a control system of the binding process unit 40. The control system of the binding process unit 40 shown in FIG. 7 is constituted so as to include the control unit 50, a motor drive unit 44a, and a signal processing unit 44b.

The control unit 50 has a system bus 55 to which an I/O port 54, ROM 53, RAM 52, and CPU 51 are connected. For example, program (binding component acquisition control program) for controlling the movement mechanism 41 to acquire the binding component 43 is stored in the ROM 53. The RAM 52 is used as a work memory when the binding component 43 is controlled and acquired based on the binding component acquisition control program. With respect to the RAM 52, it is configured that a general-purpose memory is used and comparative reference values at the time of the motor control and the number of steps for a stepping motor are temporarily stored.

The motor drive unit 44a and the signal processing unit 44b are connected to the I/O port 54. A binding component size sensor 45f and an external terminal are connected to the signal processing unit 44b. For example, with respect to the binding component size sensor 45f, a reflection type optical sensor is used. The binding component size sensor 45f detects a size of the binding component 43 of the lowest layer stacked and stored in the binder cassette 42 and outputs a binding component size signal S45f to the signal processing unit 44b. The signal processing unit 44b, to which the outputted binding component size signal S45f is inputted, binarizes (digitalizes) the binding component size signal S45f and outputs three-bit detection data to the CPU 51, for example. A detection method of the size of the binding component 43, for example, is a method that detects difference of the places where the binding components 43 contact the binder cassette 42 owing to the difference in the sizes of the binding components 43.

Also, the copy machine (which is not shown) or the like is connected to the external terminal. For example, information on the number of the paper-sheets for one booklet printed by the copy machine combined with the binding device 100 is outputted through the external terminal to the signal processing unit 44b as a defined number-of-sheet signal S45g and, the signal processing unit 44b binarizes the outputted defined number-of-sheet signal S45g and outputs a detected data Dp to the CPU 51. The CPU 51 inputted requires the motor drive unit 44a to allow the movement mechanism 41 to carry out the binding process when it determines that the paper-sheets 3″ for one booklet are stored in the paper alignment unit 30 shown in FIG. 3 based on the detected data Dp.

The motor drive unit 44a is connected to a motor 45a for rotating the movement mechanism, a motor 45b for moving the gripping portion up and down, a motor 45c for opening and closing the gripping claws, a motor 45d for opening and closing the binding claws, a motor 45e for adjusting the gripping portion, and a motor 45f for adjusting the binding component, which are disposed in the movement mechanism 41, and is also connected to the CPU 51 through the I/O port 54.

The CPU 51, for example, outputs a motor controlling data Dm to the motor drive unit 44a through the I/O port when the detected data Dp obtained by binarizing the aforementioned defined number-of-sheet signal S45g is inputted to it. The motor drive unit 44a, to which the outputted motor controlling data Dm is inputted, outputs a signal S45b for moving gripping portion up and down, which is obtained by decoding the motor controlling data Dm, to the motor 45b for moving the gripping portion up and down to drive the motor 45b for moving the gripping portion up and down, thereby moving the binding component gripping portion 41b to the upward direction thereof up to a position where it can acquire the binding component 43 of the lowest layer which is stacked in the binder cassette 42.

After the binding component gripping portion 41b has moved to the upward direction thereof up to the position where it can obtain the binding component 43, the CPU 51 outputs the motor controlling data Dm to the motor drive unit 44a through the I/O port. The motor drive unit 44a, to which the outputted motor controlling data Dm is inputted, outputs a signal S45c for opening and closing the gripping claws, which is obtained by decoding the motor controlling data Dm, to the motor 45c for opening and closing the gripping claws to drive the motor 45c for opening and closing the gripping claws, thereby acquiring the binding component 43.

After the binding component gripping portion 41b has acquired the binding component 43, the CPU 51 outputs the motor controlling data Dm to the motor drive unit 44a through the I/O port. The motor drive unit 44a, to which the outputted motor controlling data Dm is inputted, outputs the signal S45b for moving the gripping portion up and down, which is obtained by decoding the motor controlling data Dm, to the motor 45b for moving the gripping portion up and down to drive the motor 45b for moving the gripping portion up and down, thereby moving the binding component gripping portion 41b that acquires the binding component 43 to the downward direction.

The CPU 51 outputs the motor controlling data Dm to the motor drive unit 44a through the I/O port. The motor drive unit 44a, to which the outputted motor controlling data Dm is inputted, outputs a signal S45e for adjusting the gripping portion, which is obtained by decoding the motor controlling data Dm, to the motor 45e for adjusting the gripping portion to drive the motor 45e for adjusting the gripping portion in conformity with a size of a diameter of the binding component 43.

The CPU 51 outputs the motor controlling data Dm to the motor drive unit 44a through the I/O port. The motor drive unit 44a, to which the outputted motor controlling data Dm is inputted, outputs a signal S45f for adjusting the binding component, which is obtained by decoding the motor controlling data Dm, to the motor 45f for adjusting the binding component to drive the motor 45f for adjusting the binding component, thereby adjusting a stroke where the binding component is inserted in accordance with the size of the diameter of binding component 43.

Here, the CPU 51 outputs the motor controlling data Dm to the motor drive unit 44a through the I/O port. The motor drive unit 44a, to which the outputted motor controlling data Dm is inputted, outputs a signal S45d for opening and closing the binding claws, which is obtained by decoding the motor controlling data Dm, to the motor 45d for opening and closing the binding claws to drive the motor 45d for opening and closing the binding claws in conformity with the size of the diameter of the binding component 43. Thus, the binding process in response to the sizes of the binding components 43 can be realized. These series of operations will be described with reference to FIGS. 16A to 16D and FIGS. 17A to 17D.

FIG. 8A and FIG. 8B are conceptual diagrams of cross section showing a configuration example of the movement mechanism 41. The movement mechanism 41 shown in FIG. 8A shows a state in which the binding component gripping portion 41b is positioned at the lowermost portion and the movement mechanism 41 shown in FIG. 8B is a state in which the binding component gripping portion 41b is the uppermost portion. For carrying out the up and down movement of the binding component gripping portion 41b, the movement mechanism 41 has the binding component gripping portion 41b, the opening portion 41c, a gripping portion link coupling portion 41e, a gripping portion link 41f, a cam 41g for the gripping portion, and gripping portion coupling hole 41i. The binding component gripping portion 41b has two or more binding component gripping claws 41h in an upper end portion thereof and the binding component gripping claws 41h are used to grip the binding component 43 when the binding component 43 stacked in the binder cassette 42 shown in FIG. 3 is acquired.

The binding component gripping portion 41b has a convexity shaped gripping portion link coupling portion 41e in the side surface thereof. The gripping portion link coupling portion 41e is inserted into the slot-shaped gripping portion coupling hole 41i of the gripping portion link 41f, so it becomes a state in which the binding component gripping portion 41b and the gripping portion link 41f are connected. It is constituted that the gripping portion link 41f is jointed to a cam 41g for the gripping portion and is rotatable on the axis of a gripping portion link rotating axis 41j by rotating the cam 41g for the gripping portion.

By rotating the gripping portion link 41f in response to rotation of the cam 41g for the gripping portion, the position and posture of the gripping portion coupling hole 41i are changed, consequently the binding component gripping portion 41b moves upward and downward through the gripping portion link coupling portion 41e, as shown in an arrow D. The binding component gripping portion 41b has a movable constitution from the lowermost portion shown in FIG. 8A to the uppermost portion shown in FIG. 8B.

The control of the up and down movement in the binding component gripping portion 41b is carried out by the control unit 50 shown in FIG. 7 which drives the motor 45b for moving the gripping portion up and down on the basis of the motor controlling data Dm to rotate the cam 41g for the gripping portion.

Next, a configuration of the binding component 43 that is used will be explained. FIGS. 9A to 9D are explanatory diagrams showing a configuration example of the binding component 43. The binding component 43 shown in FIG. 9A is a plan view showing a portion of the binding component 43. The binding component 43 has a backbone portion 43a, a ring portion A43d, a ring portion B43c, a ring portion C43e, a pin 43f, a coupling portion A43g and a coupling portion B43h. The binding component 43 is an injection molded plastic component such that ring portions 43b are arranged with a constant interval on the backbone portion 43a with a length in conformity with a size of standard-size paper. FIG. 9B is a diagram showing a state seen from an arrow B in FIG. 9A. As shown in FIG. 9B, the ring portion 43b has a constitution such that it is partitioned into three such as the ring portion B43c connected to the backbone portion 43a, the ring portion A43d, and the ring portion C43e, which are jointed to the right and left thereof in the bend-free manner, and the coupling portion A43g and the coupling portion B43h are connected by bending them in their direction where the ring portion 43b becomes a ring shape, so that the ring portion 43b becomes a ring shape. FIG. 9C is a C-C sectional view of FIG. 9A. A shape of the backbone portion 43a cross-section of the binding component 43 shown in FIG. 9C is a convexity and this shape is for gripping the binding component 43 by the reverse L letter type shaped binding component gripping claw 41h. FIG. 9D is a state, in which plural binding components 43 are stacked, seen from the arrow B of FIG. 9A. Also, as shown in FIGS. 9A to 9C, the ring portion B43c of a predetermined ring portion 43b has a convexity shaped pin 43f. An insertion hole, which is not shown, corresponding to the pin 43f is provided at the opposite side of the ring portion B43c provided with the pin 43f. Thus, a plurality of binding components 43 can be stacked by inserting the pin 43f into the insertion hole in a state in which respective both end portions of the ring portion A43d, the ring portion B43c, and the ring portion C43e are aligned on a straight line.

FIGS. 10A to 10C are explanatory diagrams showing a configuration example (open-close) of the binding component 43 and are states in which open-close operations of the ring portion 43b are seen from the arrow B direction of FIG. 9A.

Also, as shown in FIGS. 10A to 10C, the ring portion 43b is constituted in the bend-free manner at a joint portion between the ring portion A43d and the ring portion B43c and a joint portion between the ring portion B43c and the ring portion C43e, and is constituted so that a coupling portion A43g provided in a tip portion of the ring portion A43d and a coupling portion B43h provided in a tip portion of the ring portion C43e can be coupled. Thus, it is constituted such that a perfect ring can be formed by connecting the coupling portion A43g to the coupling portion B43h by bending the ring portion A43d and the ring portion C43e in the annular direction from a state in which respective both end portions of the ring portion A43d, the ring portion B43c, and the ring portion C43e are aligned on a straight line. In addition, the coupling portion A43g and the coupling portion B43h can carry out the coupling and removal in many times, thereby being able to reuse the binding component 43.

Also, with respect to the binding component 43 explained in FIG. and FIG. 10, plural kinds that the sizes or the like of the ring portion 43b are different are used in response to the thickness of the paper-sheet 3′ and the bundle of paper-sheets 3″ shown in FIG. 2. Further, although the binding component 43 has explained in FIG. 9 and FIG. 10 that the ring portion 43b has a constitution partitioned into three pieces such as the ring portion A43d, the ring portion B43c, and the ring portion C43e, a configuration such that the ring portion 43b is partitioned by n (n is natural number) pieces may be approved.

FIG. 11A and FIG. 11B are conceptual diagrams of cross section showing a configuration example of the movement mechanism 41 (binding the binding component of large diameter) and one component diagram. The movement mechanism 41 shown in FIG. 11A is a state in which the binding component 43 of large diameter is inserted. The movement mechanism 41 has the opening portion 41c, binding claws 41k, a binding claw link A411, a binding claw link B41m, a binding claw link C41n, a spring 41o, a cam 41p for the binding claws, a cam 41u for adjusting the binding component, and a binding component adjustment portion 461 and carries out the open and close of the binding claws 41k. The binding claws 41k constitute one example of the insertion member, and push both tip portions of the binding component 43 held by the binding component gripping portion 41b inside from the both sides to insert the both tip portions of the binding component 43 into the perforated holes of the paper-sheets.

The binding claws 41k are connected to the binding claw links A411 and move parallel to the right and left. The binding claw links A411 have a binding claw link A rotating axis 41r and a link coupling portion A46j and are connected to the binding claw link B41m through the link coupling portion A46j. The binding claw link B41m has a binding claw link B coupling hole 41s and a link coupling portion B46k.

The binding claw link B41m shown in FIG. 11B is such that the binding claw link B41m shown in FIG. 11A is extracted and enlarged. The binding claw link B coupling hole 41s has switch-modes of a coupling hole R1 for small diameter, a coupling hole R2 for medium diameter, and a coupling hole R3 for large diameter and is switchable in the three-steps manner. A pitch H1 for small diameter is a distance between the coupling hole R1 for small diameter and a link coupling portion A. A pitch H2 for large diameter is a distance between the coupling hole R3 for large diameter and the link coupling portion A. When the pitch H1 for small diameter and the pitch H2 for large diameter are compared, the pitch H2 for large diameter is made longer. Thus, with respect to the binding component 43 for large diameter in comparison with the binding component 43 for small diameter, a stroke for binding the binding component 43 by the binding claws 41k becomes small, so that the binding stroke for large diameter can be made small.

The binding claw link B41m is connected to the binding claw link C41n by the link coupling portion B46k. The binding claw link C41n has a binding claw link C rotating axis 41t and a motive force is transmitted to it by the cam 41p for the binding claws so that it rotates counterclockwise on the axis of the binding claw link C rotating axis 41t in a case of binding the binding component 43. Also, the binding claw link B41m is provided with a spring 41o and any force is always applied to it toward the left upper direction. This is for preventing wobble or the like of the binding claw link B41m or the like when the position of the binding claw link B coupling hole 41s is changed and for raising the accuracy of the binding process.

The cam 41u for adjusting the binding component is driven by the motor 45f for adjusting the binding component shown in FIG. 7 and allows the binding component adjust portion 461 to move parallel toward the left and right. The binding claw link B41m connected with the binding component adjust portion 461 moves to the left and right on the axis of the link coupling portion A46j, so that the position of the binding claw link B coupling hole 41s is changes by the size of the binding component 43. When the binding components of the different diameter are bound, the load imposed onto an arc portion of the binding component can be kept substantially constant.

The movement mechanism 41 shown in FIG. 11A, for example, the cam 41p for the binding claws is rotated to a arrow direction F by using the motor 45d for opening and closing the binding claw (which is not shown). Any motive force is transmitted to the binding claw link C41n by rotating the cam 41p for the binding claws and the binding claw link C41n is pushed down on the axis of the binding claw link C rotating axis 41t. The binding claw link C pushed down pushes down the binding claw link B41m connected by the link coupling portion B46k. The binding claw link B41m pushed down by the binding claw link C41n pushes down the binding claw link A411 connected by the link coupling portion A46j. The binding claw link A411 pushed down by the binding claw link B41m moves parallel toward the E direction where the binding portion 41q binds the binding claws 41k touching the arc portion of the binding component 43 and binds the binding component 43.

FIG. 12 is a conceptual diagram of a cross section showing a configuration example (binding of the binding component of small diameter) of the movement mechanism 41. The movement mechanism 41 shown in FIG. 12 is a state in which the binding component 43 of small diameter is inserted. Because the binding component 43 is the small diameter, the link coupling portion B46k is set to the coupling hole R1 for small diameter shown in FIG. 11B. Thus, in a case in which the binding component 43 of small diameter is bound by the right and left binding claws 41k, the larger stroke can be taken in comparison with one of the binding component 43 of large diameter. Thus, even when the binding components 43 of different diameters are bound, the load imposed onto an arc portion of any of the binding components 43 can be kept substantially constant.

FIG. 13 is a conceptual diagram of a cross section showing a configuration example of the movement mechanism 41 (holding of the binding component of large diameter). The movement mechanism 41 shown in FIG. 13 is provided with a binding component gripping portion 41b and a cam 47a for adjusting position. The binding component gripping portion 41b has a cam receiving surface 47c. The cam 47a for adjusting position has a cam rotational fulcrum 47b and allows the motor 45e for adjusting the gripping portion explained in FIG. 8A and FIG. 8B to be employed as a driving source. For example, a shape of the cam 47a for adjusting position is an ellipse. A position of the cam rotational fulcrum 47b of the cam 47a for adjusting position, for example, is shifted by only the length of about one-half of the radius in the direction of the longer diameter of the ellipse from the center. Specifically, in the longer diameter of the ellipse, it is positioned at one-fourth from one end and at three-fourth from the other end. Thus, the height adjustment of the binding component gripping portion 41b can be carried out with respect to each of the large and small diameters of the binding components 43.

The movement mechanism 41 receives the binding component size signal S45f explained in FIG. 8A and FIG. 8B from the binder cassette 42 before acquiring the binding component 43 from the binder cassette 42. For example, if the binding component size signal S45f indicates the large diameter, the movement mechanism 41 drives the motor 45e for adjusting the gripping portion and rotates the cam 47a for adjusting position on the axis of the cam rotational fulcrum 47b and, for example, fixes it at one-fourth length from one end in the longer diameter of the ellipse. The rotational direction may be the clockwise or the semi-clockwise. Thus, when the binding components 43 of the different diameters are bound, the load imposed onto the arc portion of any of the binding components 43 can be kept substantially constant.

FIG. 14 is a conceptual diagram of a cross section showing a configuration example (holding of the binding component of small diameter) of the movement mechanism 41. The movement mechanism 41 shown in FIG. 14 is provided with the binding component gripping portion 41b and the cam 47a for adjusting position. The binding component gripping portion 41b has the cam receiving surface 47c. The cam 47a for adjusting position has the cam rotational fulcrum 47b and allows the motor 45e for adjusting the gripping portion explained in FIG. 7 to be employed as the driving source. For example, the shape of the cam 47e for adjusting position is the ellipse. A position of the cam rotational fulcrum 47b of the cam 47a for adjusting position is shifted by only the length of about one-half of the radius in a direction of the longer diameter of the ellipse from the center. Specifically, in the longer diameter of the ellipse, it is positioned at one-fourth from one end and at three-fourth from the other end. Thus, the height adjustment of the binding component gripping portion 41b can be carried out with respect to each of the large diameter and small diameter of the binding component 43.

The movement mechanism 41 receives the binding component size signal S45f explained in FIG. 7 from the binder cassette 42 before acquiring the binding component 43 from the binder cassette 42. For example, if the binding component size signal S45f indicates the small diameter, the movement mechanism 41 drives the motor for adjusting the gripping portion 45e and rotates the cam 47a for adjusting position on the axis of the cam rotational fulcrum 47b and, for example, fixes it at third-fourth length from the other end in the longer diameter of the ellipse. The rotational direction may be the clockwise or the semi-clockwise. Thus, when the binding components 43 of the different diameters are bound, the load imposed onto the arc portion of any of the binding components 43 can be kept substantially constant.

FIG. 15A and FIG. 15B are conceptual diagrams of a portion of cross section showing function examples of the movement mechanism 41. The movement mechanism 41 shown in FIG. 15A is a state in which two binding claws 41k are moved to each other to the directions of arrows E and the binding component 43 of large diameter is inserted. W1 is a distance between the two binding claws 41k when the binding component 43 of large diameter is inserted. W2 is a distance between each of the binding claws 41k and the binding component gripping portion 41b when the binding component 43 of large diameter is inserted.

The movement mechanism 41 shown in FIG. 15B is a state in which two binding claws 41k are moved to each other to the directions of arrows G and the binding component 43 of small diameter is inserted. W3 is a distance between the two binding claws 41k when the binding component 43 of small diameter is inserted. W4 is a distance between each of the binding claws 41k and the binding component gripping portion 41b when the binding component 43 of small diameter is inserted.

When the W1 and the W3, which are the distance between the binding claws 41k for large diameter and the distance between ones for small diameter, are compared, it becomes W1>W3. As shown in FIG. 11 and FIG. 12, this is for adjusting the binding stroke in conformity with the size of diameter of the binding component if the binding component 43 for large or small diameter is bound by the binding claws 41k.

When the W2 and the W4, which are the distance between each of the binding claws 41k and the binding component gripping portion 41b, are compared, it becomes W2>W4. This is because the most suitable position where the binding portions 41q that are tips of the binding claws 41k are attached to the arc portion of the binding component 43 is different in the binding component 43 for large or small diameter, in a case in which the binding component 43 is inserted by using the binding claws 41k. Thus, the load imposed onto an arc portion of any of the binding components 43 can be kept substantially constant when the binding components 43 of different diameters are bound.

FIGS. 16A to 16D are explanatory diagrams showing operation examples (binding component acquisition) of the movement mechanism 41. The movement mechanism 41 shown in FIGS. 16A to 16D is the same configuration example of the movement mechanism 41 shown in FIG. 8A and FIG. 8B. The binder cassette 42 is shown so that the state of interior can be seen with leaving the lower portion by about one-fifth to understand the operation process of extracting the binding component 43. The movement mechanism 41 shown in FIG. 16A is a state in which the binding component gripping portion 41b is positioned in the lowermost portion (hereinafter, referred to as standby state) before the control unit 50 receives the defined number-of-sheet signal S45g shown in FIG. 7. The movement mechanism 41 shown in FIG. 16B is a state in which after the control unit 50 received the defined number-of-sheet signal S45g, the binding component gripping portion 41b is moved up to the uppermost portion and the binding component 43 is gripped by the binding component gripping claws 41h. The movement mechanism 41 shown in FIG. 16C is a state in which the binding component 43 is gripped by the binding component gripping claws 41h and extracted from the binder cassette 42. The movement mechanism 41 shown in FIG. 16D is constituted such that after the binding component 43 is gripped by the binding component gripping claws 41h and extracted from the binder cassette 42, the stroke of the binding claws 41k is adjusted in conformity with the size of diameter of the binding component 43 in the manner shown in FIG. 11 and FIG. 12 and also, the binding component gripping portion 41b is moved to the downward direction to a specified position in the manner shown in FIG. 13 and FIG. 14 and the binding component 43 is made to be a half-binding state (hereinafter, referred to as first forming).

The binding claws 41k shown in FIG. 16D widen the distance between both tips of the binding claws 41k and put the binding component 43 on standby in a case where the binding component 43 has the large diameter, and narrow the distance between the both tips of the binding claws 41k and put the binding component 43 on standby in a case where the binding component 43 has the small diameter. The binding component gripping portion 41b allows an arc portion of the binding component 43 to contact the both tips of the binding claws 41k put on standby and also fixes the binding component 43 at the position where the both tips of the binding claws 41k become the vicinity of the both tips of the binding component 43. The binding claws 41k insert the both tips of the binding component 43 fixed by the binding component gripping portion 41b into the holes perforated in the paper-sheet 3″ shown in FIG. 17A. Thus, when the binding components 43 of different diameters are bound, the load imposed onto an arc portion of any of the binding components 43 can be kept substantially constant.

FIGS. 17A to 17D are explanatory diagrams showing an operation example (binding process) of the movement mechanism 41. The movement mechanism 41 shown in FIGS. 17A to 17D is the same configuration example as the movement mechanism 41 shown in FIG. 8A and FIG. 8B. The binder cassette 42 is shown so that the state of interior can be seen with leaving the lower portion by about one-fifth to understand the operation process of extracting the binding component 43. The movement mechanism 41 shown in FIG. 17A is a state in which it is rotated counterclockwise on the axis of the movement mechanism rotating axis 41d shown in FIG. 4 from the first forming and moves to the paper alignment unit 30. The paper-sheet 3″ is such that only the paper-sheet 3″ is extracted from the paper alignment unit 30 shown in FIG. 4. The movement mechanism 41 shown in FIG. 17B is a state in which the paper alignment unit 30 inserts the paper-sheet 3″ into the opening portion 41c of the movement mechanism 41. The movement mechanism 41 shown in FIG. 17C is a state in which the paper-sheet 3″ inserted into the opening portion 41c of the movement mechanism 41 by the paper alignment unit 30 is inserted with the binding component 43 and becomes the booklet 90. The movement mechanism 41 shown in FIG. 17D is a state in which the paper alignment unit 30 moves the booklet 90 inserted with the binding component 43 to the arrow direction. The booklet 90 is delivered to the subsequent progress. The movement mechanism 41 moves to the standby state shown in FIG. 16A.

In such manner, according to the paper-sheet handling device according to the present invention, the movement mechanism 41 for inserting the both tips of the binding component 43 into the perforated holes of the paper-sheet 3 is provided, this movement mechanism 41 holds the binding component 43 of a predetermined size in the opened state thereof and has a binding component gripping portion 41b which is adjustable upward and downward in conformity with a size of a diameter of the binding component 43 and binding claws 41k for pushing the both tips of the binding component 43 inside from both sides to insert them into the perforated holes of the paper-sheet 3.

Accordingly, the both tips of the binding claws 41k are attached to the most suitable position with respect to the arc portion of each of the binding components 43 of different diameters, so that the load imposed onto the arc portion of any of the binding component 43 can be kept substantially constant. Thus, the useless load imposed onto the arc portion comes to be able to be eliminated. Therefore, the miniaturization of the motors and components becomes possible and the environmental load can be reduced.

It should be noted that although the binding component gripping portion 41b has adjusted upward and downward and the binding claws 41k have been fixed and not moved up and down in the embodiment of the present invention, it may be considered that the binding claws 41k are adjustable upward and downward and the binding component gripping portion 41b is fixed and not moved up and down. Further, it may be considered that the binding component gripping portion 41b is adjustable upward and downward and also, the binding claws 41k are adjustable upward and downward.

### INDUSTRIAL APPLICABILITY

It is very preferable that the invention is applied to a binding device for performing the binding processing on the recording paper-sheets released from a copy machine or a print machine for black-and-white use and for color use.

1-2. (canceled)

3. A paper-sheet handling device for producing a booklet by binding a binding component into holes perforated at predetermined positions of respective plural paper-sheets, wherein the paper-sheet handling device contains:
a binding component storing unit for storing the binding component of a predetermined size that is developed before processing and becomes a ring shape after the processing; and
binding means for receiving the binding component of the predetermined size from said binding component storing unit, and for binding said binding component into the holes perforated at predetermined positions of said paper-sheets,
wherein said binding means includes an insertion mechanism for inserting both tips of said binding component into the perforated holes of said paper-sheets, and
wherein said insertion mechanism includes a holding member which holds said binding component of the predetermined size in an opened state thereof, and which is adjustable upward and downward in conformity with a size of a diameter of said binding component, and an insertion member for inserting both tips of said binding component held by said holding member into the perforated holes of said paper sheets by pushing both tips of said binding component to inside from both sides.

4. The paper-sheet handling device according to claim 3, wherein:
said insertion member adjusts a distance between both tips of said insertion member and waits for receiving the binding component;
said holding member allows the arc portion of said binding component to contact both tips of said insertion member that waits for receiving the binding component, and also fixes said binding component at a position in which both tips of said insertion member are in the vicinity of both tips of said binding component; and
said insertion member inserts both tips of said binding component fixed by said holding member into the holes perforated in said paper-sheets.

5. The paper-sheet handling device according to claim 3, wherein said insertion member widens the distance between both tips of said insertion member and waits for receiving the binding component.

6. The paper-sheet handling device according to claim 3, wherein said insertion member narrows the distance between both tips of said insertion member and waits for receiving the binding component.
